(19) United States
(12) Patent Application Publication
(10) Pub. No.: US 2021/0331521 A1
(43) Pub. Date: Oct. 28, 2021

(54) Improved Wheel and Wheel Attachment

(71) Applicant: GECKO TYRE PTY LTD, Fairfield, Victoria (AU)

(72) Inventors: Ryan Kendall Tilley, Fairfield, Victoria (AU); Huy Nguyen, Fairfield, Victoria (AU)

(21) Appl. No.: 17/270,511

(22) PCT Filed: Aug. 11, 2019
(86) PCT No.: PCT/AU2019/050838

§ 371 Date: Feb. 23, 2021

Related U.S. Application Data
(60) Provisional application No. 62/723,069, filed on Aug. 27, 2018.

(51) Int. Cl. B60C 7/24; B60C 7/12

(52) U.S. Cl. CPC B60C 7/24; A61G 5/10; A61G 2203/70; B60C 7/125

(57) ABSTRACT

A rolling element such as a wheel and wheel attachment or caterpillar type rolling element for improving support. A rolling element includes: a first support surface formed as a loop configured to roll on a substrate such that a region of the first support surface alternately contacts and separates from the substrate, a first extension running about the loop and disposed about the first support surface, wherein where the rolling element is disposed on the substrate and a load is applied thereto: in a first region of the loop where the first support surface is separate from the substrate the first extension extends beyond the first support surface, and in a second region of the loop where the first support surface contacts the substrate the first extension is deformed so as to form a second support surface which contacts the substrate.

### FIELD OF THE INVENTION

The present invention relates to generally to the field of rolling means. In particular, but not exclusively, the invention relates to a wheel per se, and an attachment that may be applied to a wheel to improve support as required. The wheel and wheel attachment may be useful in improving support in a range of wheeled contrivances including but not limited to wheelchairs, bicycles, infant pushers and strollers, road vehicles, off-road vehicles, heavy vehicles, trolleys, and trailers. The invention extends also to other forms of rolling means such as caterpillar-type rolling means.

### BACKGROUND TO THE INVENTION

A wheel functions optimally when supported by a solid surface. In that situation, the wheel is able to present a sufficiently large contact area with the substrate so as to provide the required level of traction, however not so large so as to result in an unacceptable level of drag. For example, an automobile tyre is provided with sufficient support by an underlying solid asphalt road and is there able to contact and frictionally engage with the road surface whilst limiting the amount of drag.

However, in circumstances where a substrate is not solid a wheel may sink downwardly into the substrate and become “bogged”. Substrates in which a wheel may become bogged include soft soil, mud, sand, gravel, vegetation (such as soft grass) and snow. The downward force contributing to the sinking may be provided by the weight of the wheel itself, the weight of a vehicle which rolls on the wheel, the weight of a load placed on the wheel, or a combination thereof.

Where the substrate is very soft, a wheel may sink even down to the level of the axle. As will be appreciated, a sunken wheel may be resistant to or incapable of active or passive rotation given that it becomes essentially surrounded by the substrate. In that circumstance, the frictional resistance of the substrate bearing against a large surface area of the wheel is clearly far greater than that which is required to provide traction.

This resistance to rotation presents significant problems where the wheel is hand driven (such as a wheelchair) or foot driven (such as a bicycle). Problem also presents where a wheel is not directly driven, but is instead rotated by a forward motion of a vehicle such as occurs where an infant stroller is pushed over a substrate. In such situations, the user may not possess sufficient strength to drive the wheels of a wheelchair or push the stroller.

The propensity of a wheel to sink into a soft substrate is increased where the wheel is narrow and in which case a highly concentrated load force is imparted on a small area of substrate. For example, a rear wheelchair tyre is relatively narrow and are therefore more liable to sink into a soft substrate such as mud, sand, gravel and the like. This problem is addressed in the prior art by the provision of wheelchairs having wide format wheels so as to spread the load over a larger area of substrate. Such wheels dramatically increase the width of the wheelchair causing difficulties in passing through doorways, being stowed in a vehicle, or handling in the course of air travel. Furthermore, a wheelchair user is forced to maintain two wheelchairs (one for normal use and another for use on soft substrates), that situation being greatly uneconomical for the user.

A narrow wheel also presents difficulties where a substrate is essentially solid, but presents an uneven surface such as a potholed concrete path or rocky terrain. In these situations a narrow wheel may become wedged or trapped in some way. In other situations, the user may experience an unduly uncomfortable ride due to the unevenness. In developing regions of the world it is not uncommon for a path, road or other substrate upon which a wheelchair user is required to traverse to be uneven. The unevenness in the substrate can present practical difficulties for a wheelchair user attempting to travel any reasonable distance. As will be appreciated, the present invention provides a low cost solution for wheelchair users in developing nations.

Some wheelchairs allow for the substitution of wide format wheels for regular wheels so as to overcome the difficulties outlined above. A user may therefore attach the regular width wheels for use on hard surfaces, and then switch to wide format wheels before travelling over a soft substrate. This approach requires the user to keep replacement wheels at hand, and then when required must remove the regular tyres and replace with wide format wheels. Of course, carrying extra wheels is a significant inconvenience.

Furthermore, in order to change the wheels the user is forced to exit the wheelchair, and then return to the chair when the replacement wheels are attached. Many wheelchair users have little or no motor function in the legs, and could only effect wheel replacement with the assistance of another person. Of course, independence is a significant aim of many wheelchair users, with the requirement for an assistant to accompany the user to effect wheel replacement is therefore generally undesirable.

Quite apart from the problems relating to the use of wide format wheels described above, such tyres interfere with the normal manner in which a user manually self-propels the wheelchair. Specially, the push rim of the wheel must be disposed laterally and outwardly a significant distance thereby requiring the user to reach outwardly and laterally in order to contact and drive the push rim. In many instances the user will be physically unable to make contact, and even if contact is made the ability to drive the push rim is significantly decreased due to the compromise in biomechanics. Best power is gained where the user's arms are kept close to the body (i.e. medial) with any outward lateral displacement of the arms leading to a decrease in torque. Again, independence is a significant aim of wheelchair users and the need for an assistant to push his/her wheelchair when using wide format wheels is generally undesirable.

In non-wheelchair applications, the use of a wide format wheel can lead to an undesirable increase in width of the vehicle overall. For example, an infant stroller having wide format wheels can be difficult to fit into an automobile boot (trunk), and in some instances even prevent the stroller from passing through a doorway.

For powered and unpowered vehicles, wide format wheels cause design difficulties given the need to configure a wheel arch, wheel well, axle, or vehicle frame to accommodate the broad wheel. Furthermore, wide format tyres are more expensive than regular width tyres and typically the user will only wish to use the more expensive tyres when absolutely necessary to limit wear. The time and effort involved in changing from regular to wide format tyres and vice versa presents a further significant problem in the art.

A further problem in the art is the reduction in traction that occurs where a wheel is disposed on low friction substrate such as ice, or an asphalt road covering in a layer or water. The loss of traction can result in a drive wheel spinning uncontrollably (and leading to no forward propulsion), or a loss of steering and braking control. In automobiles and trucks the reduction in support of a pneumatic tyre in conditions of snow and ice is addressed by the use of snow chains. The chains function by biting into the underlying snow or ice, thereby improving traction. A similar approach is the used of studded tyres, with the studs acting to improve frictional engagement greater of the tyre with a snow or ice substrate.

A problem of these prior art approaches is that the underlying road can be damaged where the chains or studs make contact. A further problem is the need to remove the chains, or replace studded tyres for regular tyres when increased support is no longer required.

As for the problem of a wheel sinking, traction may be improved by the use of wide format tyres. However, the same or similar problems arise as detailed above.

It is an aspect of the present invention to provide an improvement to prior wheels and wheels so as to improve sinking resistance and/or traction. It is a further aspect of the invention to provide a useful alternative to prior art wheels.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each provisional claim of this application.

### SUMMARY OF THE INVENTION

In a first aspect, but not necessarily the broadest aspect, the present invention provides a rolling means comprising: a first support surface formed as a loop configured to roll on a substrate such that a region of the first support surface alternately contacts and separates from the substrate, a first extension running about the loop and disposed about the first support surface, wherein where the rolling means is disposed on the substrate and a load is applied thereto: in a first region of the loop where the first support surface is separate from the substrate the first extension extends beyond the first support surface, and in a second region of the loop where the first support surface contacts the substrate the first extension is deformed so as to form a second support surface which contacts the substrate.

In one embodiment of the first aspect, the rolling means comprises a second extension running about the loop, the second extension being disposed about the first support surface, wherein where the rolling means is disposed on the substrate and a load is applied thereto: in a first region of the loop where the first support surface is separate from the substrate the second extension extends beyond the first support surface, and in a second region of the loop where the second support surface contacts the substrate the second extension is deformed so as to form a third support surface which contacts the substrate.

In one embodiment of the first aspect, the deformation of the first extension and the second extension (where present) in the second region of the loop is a splaying of the first extension and the second extension (where present).

In one embodiment of the first aspect, the first support surface is disposed between the first and second extensions.

In one embodiment of the first aspect, the first region of the loop the second support surface and the third support surface (where present) face generally inwardly.

In one embodiment of the first aspect, the first region of the loop the first extension and the second extension (where present) is/are splayed slightly outwardly, with the terminus of the extension(s) remaining extended beyond the first support surface.

In one embodiment of the first aspect, the substrate is substantially horizontal, planar and solid; in the second region of the loop the second support surface and the third support surface (where present) is/are substantially horizontal.

In one embodiment of the first aspect, the first support surface is the substrate-contacting surface of a wheel, or the substrate-contacting surface of a caterpillar track.

In one embodiment of the first aspect, the first extension and the second extension both have a length, and the length of the first extension is substantially the same as the second extension.

In one embodiment of the first aspect, the first extension is substantially a minor image of the second extension.

In one embodiment of the first aspect, the first extension and the second extension (where present) is/are shaped, in cross-section, such that a region proximal the first support surface is thinner than a region distal the first support surface.

In one embodiment of the first aspect, the first support surface is configured so as to, in use, provide traction on the substrate.

In one embodiment of the first aspect, the second support surface and the third support surface (where present) is/are configured so as to, in use, provide traction on the substrate.

In one embodiment of the first aspect, the first extension and the second extension (where present) is/are fabricated from a deformable and resilient material such that upon separation from the substrate the first extension and the second extension (where present) return to a default state whereby the first extension and the second extension (where present) extend beyond the first support surface.

In one embodiment of the first aspect, the first extension and the second extension (where present) is/are fabricated from a polymeric material.

In one embodiment of the first aspect, the loop is fabricated from a polymeric material to form a rollable loop, or from a series of rigid plates operably linked so as to form a rollable loop.

In one embodiment of the first aspect, where the loop and the first extension and the second extension (where present) are unitarily fabricated.

In one embodiment of the first aspect, the attachment is fabricated at least in part by an extrusion process or a moulding process.

In one embodiment of the first aspect, the load is of a magnitude that is the same or similar to that expected for a predetermined application of the rolling means.

In one embodiment of the first aspect, the load is applied to one or more points or regions of the rolling means that is the same or similar to that expected for a predetermined application of the rolling means.

In one embodiment of the first aspect, the rolling means is configured as a wheel or as a caterpillar track.

In a second aspect, the present invention provides, an attachment configured to be applied to and retained on a rolling means, the attachment comprising: a first support surface formed as (ii) a loop, or (ii) in linear form that is formable into a loop, the first support surface configured to roll on a substrate such that a region of the first support surface alternately contacts and separates from the substrate, a first extension running about or along the loop and disposed about the first support surface, wherein where the attachment is applied to a rolling means, and the rolling means is disposed on the substrate and a load is applied thereto: in a first region of the loop where the first support surface is separate from the substrate the first extension extends beyond the first support surface such that the first and second support surfaces are separate from the substrate, and in a second region of the loop where the first support surface contacts the substrate the first extensions are deformed so as to form a second support surface which contacts the substrate.

In one embodiment of the second aspect, the attachment comprises a second extension running about the loop or along the linear form, the second extension being disposed about the first support surface, wherein where the attachment is applied to a rolling means and the rolling means is disposed on the substrate and a load is applied thereto: in a first region of the loop where the first support surface is separate from the substrate the second extension extends beyond the first support surface, and in a second region of the loop where the second support surface contacts the substrate the second extension is deformed so as to form a third support surface which contacts the substrate.

In one embodiment of the second aspect, the deformation of the first extension and optionally the second extension (where present) in the second region of the loop is a splaying of the first extension and the second extension (where present).

In one embodiment of the second aspect, the first support surface is disposed between the first and second extensions.

In one embodiment of the second aspect, in the first region of the loop the second support surface and the third support surface (where present) face generally inwardly.

In one embodiment of the second aspect, in the first region of the loop the first extension and the second extension (where present) is/are splayed slightly outwardly, with the terminus of the extension(s) remaining extended beyond the first support surface.

In one embodiment of the second aspect, where the substrate is substantially planar and solid, in the second region of the loop the second support surface and the third support surface (where present) is/are substantially horizontal.

In one embodiment of the second aspect, the first support surface overlies the substrate-contacting surface of a wheel, or the substrate-contacting surface of a caterpillar track.

In one embodiment of the second aspect, the first extension and the second extension both have a length, and the length of the first extension is substantially the same as the second extension.

In one embodiment of the second aspect, the first extension is substantially a minor image of the second extension.

In one embodiment of the second aspect, the first and/or the second extension is/are shaped, in cross-section, such that a region proximal the first support surface is thinner than a region distal the first support surface.

In one embodiment of the second aspect, the first support surface is configured so as to, in use, provide traction on the substrate.

In one embodiment of the second aspect, the second support surface and the third support surface (where present) is/are configured so as to, in use, provide traction on the substrate.

In one embodiment of the second aspect, the first extension and the second extension (where present) is/are fabricated from a deformable and resilient material such that upon separation from the substrate the first and second extensions return to a default state whereby the first and second extensions extend beyond an interposed region of the first support surface.

In one embodiment of the second aspect, the first extension and the second extension (where present) is/are fabricated from a polymeric material.

In one embodiment of the second aspect, the loop is fabricated from a polymeric material, or from a series of rigid plates operably linked so as to form a rollable loop.

In one embodiment of the second aspect, where the loop and the first extension and the second extension (where present) is/are unitarily fabricated.

In one embodiment of the second aspect, the attachment is fabricated at least in part by an extrusion process or a moulding process.

In one embodiment of the second aspect, the load is of a magnitude that is the same or similar to that expected for a predetermined application of the rolling means to which the attachment is to be applied.

In one embodiment of the second aspect, the load is applied to one or more points or regions of the rolling means to which the attachment is to be applied that is the same or similar to that expected for a predetermined application of the rolling means to which the attachment is to be applied.

In one embodiment of the second aspect, the attachment is formed into a loop and configured so as to be stretched over the rolling means, and allowed to contract about the rolling means.

In one embodiment of the second aspect, the attachment is in the form of one or more lengths configured to allow attachment without stretching.

In one embodiment of the second aspect, the attachment of claim 43, formed into one or more lengths configured to be applied by pushing onto the rolling means in a direction approximately normal to the substrate-contacting surface of the rolling means to which it is to be applied.

In one embodiment of the second aspect, the attachment comprises joining means configured to allow joining two ends of the one or more lengths for the purpose of forming a loop.

In one embodiment of the second aspect, the joining means is reversible so as to allow disruption of a looped formation.

In one embodiment of the second aspect, the attachment is formed into a length, and configured so as to be applied progressively to the entirety of the substrate-contacting surface of the rolling means.

In one embodiment of the second aspect, the attachment comprises a surface shaped and dimensioned so as to snugly fit onto and be retained on a rolling means.

In one embodiment of the second aspect, the surface is generally opposed to the substrate contacting surface of the attachment.

In one embodiment of the second aspect, the attachment means has a cross sectional profile comprising opposing arms configured to (i) deform about a side wall of a rolling means during application, and (ii) resiliently grip onto the side wall when the attachment is fully seated onto the rolling means.

In one embodiment of the second aspect, the attachment means is configured such that deformation of the extensions causes the arms to grip onto the rolling means.

### BRIEF DESCRIPTION OF THE FIGURES

FIG. 1A illustrates an isometric view of a preferred wheel attachment of the present invention.

FIG. 1B illustrates an end-on profile view of the preferred wheel attachment of FIG. 1A.

FIG. 1C illustrates an enlarged view of a lowermost region of the profile view of FIG. 1B.

FIG. 2A and FIG. 2B illustrate a cross-section of the preferred wheel attachment of FIG. 1A.

FIG. 2A shows a first conformation where the attachment is not in contact with a substrate, and the extensions are in a neutral conformation.

FIG. 2B shows a second conformation where the attachment is in contact with an underlying substrate, and the extensions are in a splayed conformation, and biased to the positions shown in FIG. 2A.

FIG. 3A illustrates an isometric view of a preferred wheel attachment of the present invention showing the splaying of the extensions only in the region of the attachment about the substrate upon which it is disposed.

FIG. 3B illustrates an enlargement of the lowermost region of the attachment of FIG. 3A to show splaying of the extensions, and contact of the extensions and the central contact region of the attachment with the underlying substrate.

FIG. 4A illustrates an end-on profile view of the attachment shown in FIG. 3A.

FIG. 4B illustrates an enlargement of the lowermost region of the attachment of FIG. 4A to show splaying of the extensions, and contact of the extensions and the central contact region of the attachment with the underlying substrate.

FIG. 5 illustrates a cross-section of the wheel attachment of FIG. 1A as applied to a wheel having a pneumatic tyre. The wheel is under load (via the wheel axle, not drawn) causing the extensions to splay outwardly so as to present an increased surface are to underlying substrate.

FIG. 6A illustrates an isometric view of a preferred joining means in the disengaged conformation, as incorporated into the preferred wheel attachment shown in FIG. 1A.

FIG. 6B illustrates a cross-section through the portion of the joining means shown in FIG. 6A showing the locking members.

FIG. 6C illustrates the cross-section of FIG. 6B showing the locking function of the locking members on an underlying portion of the wheel attachment.

FIG. 7 illustrates an isometric view of the preferred joining means of FIG. 6A in the engaged conformation.

FIG. 8 illustrates a cross-section of a wheel having a solid tyre, the tyre having integral extensions.

FIG. 9 illustrates a cross-section of a wheel having a pneumatic tyre, the tyre having integral extensions.

FIG. 10 illustrates various cross-sections of alternative configurations for the extensions.

FIG. 11 illustrates an isometric view of a preferred wheel attachment of the present invention having no joining means, and intended to be stretched over a wheel.

FIG. 12 illustrates an isometric view of a section of a preferred wheel attachment of the present invention incorporating a series of generally radial slots which function to provide an ability to slightly elongate a wheel attachment (when in a linear form) or to slightly increase the circumference of a wheel attachment (when in a loop form).

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

The present invention is predicated at least in part on the inventors' discovery that sinking of a wheel into a non-solid substrate can be prevented by increasing the width of the wheel to present a greater surface are to the substrate, while at the same time preventing impact of the widened wheel with an adjacent structure such as a wheel arch, wheel well, vehicle frame member, or a mechanical component such as a suspension component or a braking component.

Where the wheel is used in the context of a wheelchair, the widened wheel is configured so as to not contact (or to contact to a lesser extent) a body part such as the hand, arm, a lateral portion of the hip or a lateral portion of the leg. Prior art wheels that have been widened or that have projections to prevent sinking in soft terrain can rub certain parts of the user's body leading to damage to the skin, or the clothing. Widened prior art wheels may also interfere with access of a user's hand to the push rims, thereby forcing the user to adopt an unnatural pushing motion with the elbows bent outwardly so as to avoid contact with the wheel.

In particular, the inventors have found that the use of extensions which when in contact with the substrate splay generally laterally to the tread portion of the wheel provide for an increase in surface area presented to the substrate. To prevent any contact with adjacent vehicle structures or the user's body, once the extensions have been moved away from the substrate (by forward or backward rotation of the wheel), the extensions recoil to a neutral position where the splaying is decreased or there is no splaying. Thus, with the extensions in the neutral position the wheel has a width which is the same or similar to that of a similar wheel which is devoid of extensions.

The present invention will be more fully described by reference to the following non-limiting embodiments.

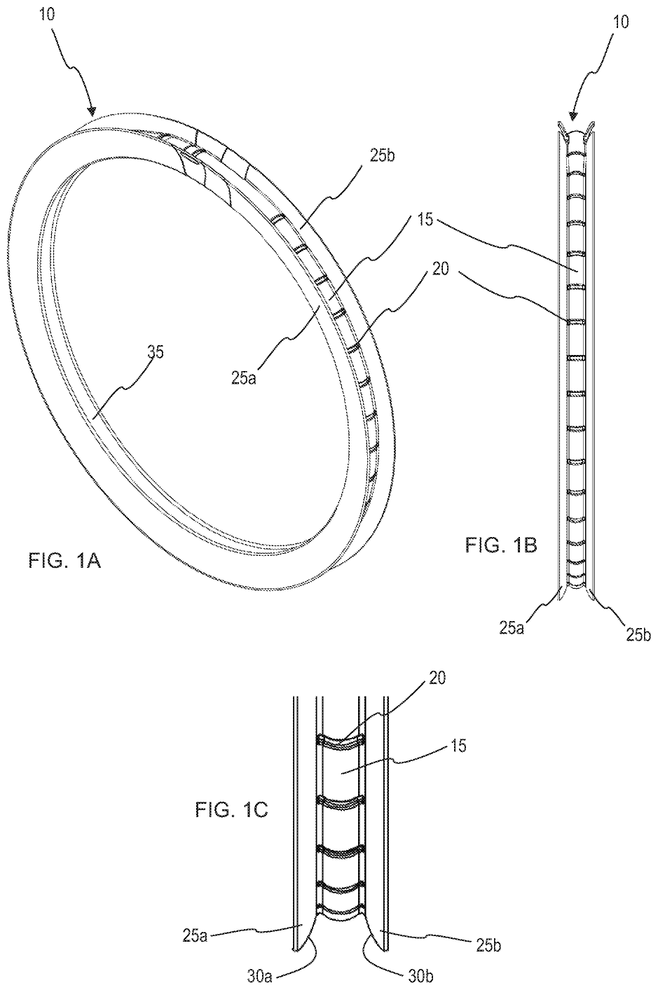

Reference is made firstly to FIG. 1A which shows in isometric view a wheel attachment 10 of the present invention configured to be applied to a prior art wheelchair wheel, bicycle wheel, or stroller wheel. The attachment is a looped structure comprising a central substrate contact surface 15 having regularly spaced transverse recesses 20. The recesses 20 function so as to improve traction against the underlying substrate (not drawn) when rolling thereupon. The substrate contact surface 15 is flanked by opposed extensions 25a and 25b each of which extend from a position lateral to the substrate contact surface and each of which extend beyond the substrate contact surface 15 to terminate at a point distal therefrom.

The end-on profile view shown in FIG. 1B shows more clearly the paired and opposed nature of the extensions 25a and 25b. The extensions 25a and 25b each have internally directed surfaces 30a and 30b respectively, as is shown more clearly in FIG. 1C.

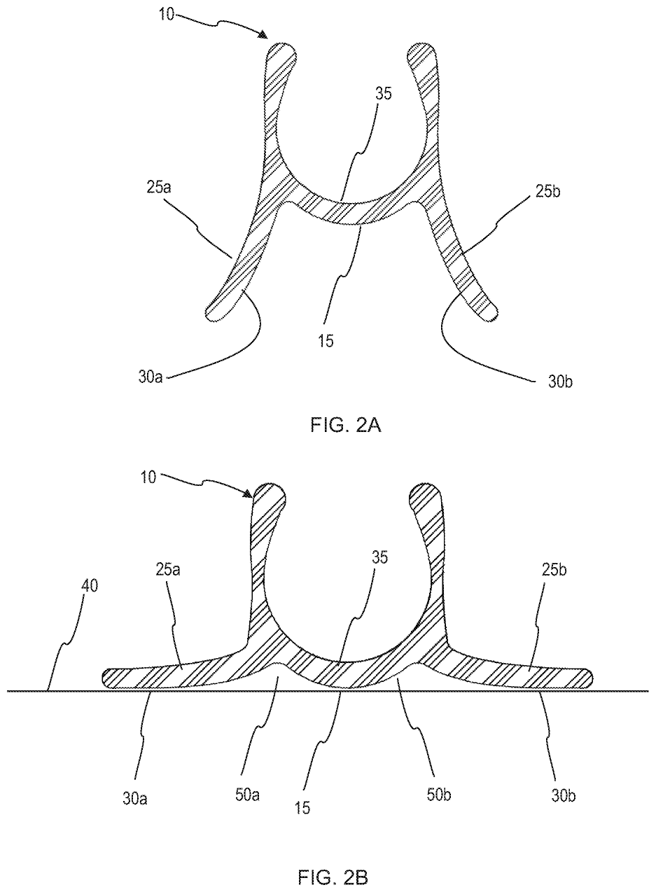

The cross-sectional view of the attachment drawn in FIG. 2A shows all features hitherto described, and also the contoured surface 35 which is shaped so as to conform about a prior art tyre. In FIG. 2A the attachment 10 is shown as it would appear when not bearing against a substrate (i.e. in a force neutral configuration). It will be noted that the extensions 25a and 25b extend well beyond the substrate contact surface, and are splayed slightly outwardly. This conformation will be seen for all positions along the attachment 10 where the extensions 25a and 25b are not in contact with the substrate and there is no load on the wheel to which it is attached, whether or not the wheel bears any load. This conformation may also be seen where the wheel is in contact with the substrate but there is no applied load, in which case the extensions 25a and 25b are sufficiently strong so as to maintain the substrate bearing surface 15 elevated above the substrate 40.

FIG. 2B shows conformation of the attachment 10 for positions along the attachment 10 that are in contact with the substrate 40 and the wheel is a loaded. The loading creates a downward force, thereby causing the extensions 25a and 25b to splay outwardly such that the inner surfaces 30a and 30b contact the substrate 40. Where the substrate is not solid, the splayed extensions 25a and 25b act to increase the surface area of the attachment 10 over and above that normally presented to the substrate 40 by the wheel to which it is attached. The surfaces 30a and 30b bear against the substrate 40 so as to provide greater resistance to the underlying wheel from sinking into the substrate 40.

The extensions 25a and 25b therefore avoid the situation whereby turning of a wheel becomes difficult or impossible due to bogging in a non-solid substrate such as sand or soft earth. Instead, the wheel is kept on the surface of the substrate by the wheel attachment, such that the substrate contacting surface 15 is able to make a small area of contact with the substrate.

In FIG. 2B, the substrate is shown as planar and solid, and this will be an accurate representation of the configuration where the attachment 10 is disposed on a concrete surface, for example. When attachment 10 is rolled onto a soft substrate, the substrate will of course deform under the weight of the wheel. In any event, the extensions 25a and 25b will nevertheless splay outwardly to increase the surface area of the attachment that contacts the underlying substrate. However, the substrate will tend to conform to the contact surfaces 15, 30a and 30b and therefore migrate into the spaces marked 50a and 50b.

Importantly, the conformation shown in FIG. 2B is seen only for regions about the circumference of the wheel that is in contact with the substrate. Regions about the circumference that are free of the contact surface 40 remain in the neutral conformation are shown in FIG. 2A. In this neutral conformation the extensions 25a and 25b extend generally radially, and therefore are less likely to contact any wheel arch or wheel well or frame of the vehicle to which the wheel (and therefore also the wheel attachment 10) is connected.

Particular advantage is noted where the attachment 10 is applied to a wheelchair wheel, and in which case the push rim of the wheel remains well exposed thereby allowing the user to make easy manual contact with the rim. If the extensions 25a and 25b remained in the loaded configuration shown in FIG. 2B in the upper regions of the wheelchair wheel they would cause significant interference to the user. The user would be compelled to bend the elbows and the wrists such that the hands could approach the push rims more laterally so as to avoid the extensions 25a and 25b. In that situation, the mechanical work that can be generated by the user (and in turn the torque applied to the wheels) would be significantly diminished. The return of the extensions 25a and 25b to their neutral positions avoids this difficulty allowing the user to contact the push rims of the wheelchair wheels normally.

In many circumstances, the present invention can be applied to a prior art wheelchair with there being no requirement to make any modifications to the wheelchair per se. For example, a wheel or wheel attachment of the present invention may replace a prior art wheel that is disposed proximal to the frame, there being no requirement to modify the wheelchair to increase the clearance between the wheel or wheel attachment and the frame. This advantage is provided because the wheel or wheel attachment of the invention assumes a narrow profile at all regions about its circumference, except for the region about the point of contact with the substrate within which the extensions splay outwardly to provide increased width.

As will be appreciated, the attachment 10 is configured such that the extensions (or at least the base of the extensions) are resiliently deformable. Accordingly, the extensions 25a and 25b are biased toward the neutral conformation shown in FIG. 2A.

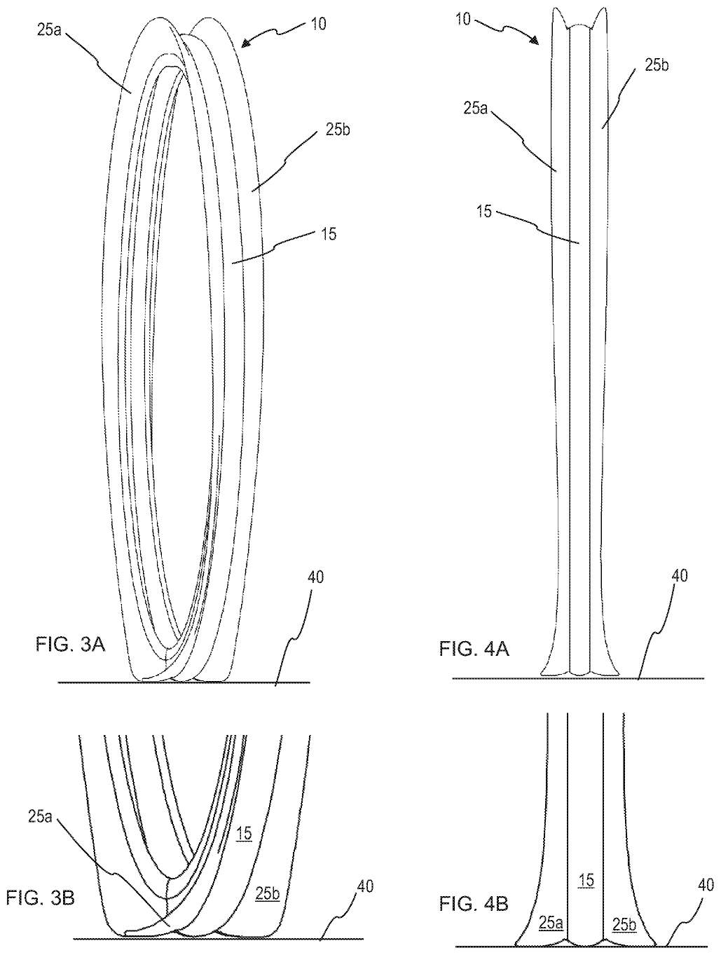

Reference is now made to FIGS. 3A, 3B, 4A and 4B which show more clearly the two conformations (splayed and neutral) of the wheel attachment 10. In FIGS. 3A and 4A, the entire wheel is drawn to show that it is only in the region of the attachment 10 about where it makes contact with the substrate 40 that the extensions 25a and 25b are splayed. In other regions about the circumference of the attachment 10 the extensions 25a and 25b assume the neutral conformation. The extensions 25a and 25b are in the neutral at the upper regions of the attachment 10, and will therefore not interfere with an adjacent structure of the vehicle (such as a wheel well or a frame member) or with the arm of a wheelchair user attempting to rotate the wheel by way of a push rim (not drawn).

Greater detail of the region of the attachment 10 contacting the substrate 40 is shown in FIGS. 3B and 4B. Especially in regard to FIG. 3B it will be apparent that the extensions 25a and 25b are fully (i.e. horizontally) splayed at the lowermost region of the wheel, with adjacent regions being in a transitional conformation whereby the extensions 25a and 25b are less than fully splayed, but not yet returned to the neutral position.

Thus, as the wheel is rotated, each point on the circumference of the wheel attachment alternates between the neutral conformation (in which it remains for the majority of the time) and the splayed or partially-splayed conformation (which it assumes for a minority of the time).

In use, the attachment 10 is most easily applied when the wheel is on a solid surface. For example, where the user is proposing to travel over sand the attachment may be applied when still on a pavement just adjacent to the sand. Thus, the wheel attachment presents an increased surface area to the pavement firstly (where it is not required) but maintains the increased surface area when rolling onto the sand (where it is required to prevent sinking). It will be appreciated that it will be possible in many circumstances to apply the attachment to a wheel which is already on a soft substrate.

In one embodiment, the attachment 10, is formed as a length (i.e. not in looped form) which can be joined at the ends to form a loop (as shown in FIG. 1A, for example). To apply the attachment 10 to a wheel, the attachment 10 is laid on a solid surface with the contoured surface 35 facing upwards. The wheel is aligned with the length of attachment 10 and rolled onto the upwardly facing contoured surface 35 such that the outer periphery of the wheel (or a tyre on the wheel) inserts into the space defined by the contoured surface 35. The wheel in continued to be rolled over the length of attachment until all has been applied the total circumference of the wheel. Once applied, the ends of the attachment 10 are secured together to form a closed loop around the wheel. As will be appreciated, the attachment 10 should be of a length that is not too short or not too long having reference to the circumference of the wheel.

In some circumstances, the wheel attachment may be configured so as to provide some flexibility in length such that a precise fit to a wheel is not necessary. For example, flexibility may be inherent due the stretchable nature of the material used to fabricate the attachment. Alternatively, structural features may be incorporated so as to confer some stretchability on the attachment. As one example of a feature, a series of radially-aligned slots or cuts may be formed in the extensions 25a, 25b and/or the lateral portions 65a, 65b. Slots or cuts formed across the support surface 15 may also assist in that regard. Reference is made to FIG. 12, showing a generally radially oriented slots 100 originating from alternating edges of attachment. To facilitate stretching, the termini of a slot or cut may be formed into a rounded aperture 105 as shown in respect of the slots 100 drawn in FIG. 12. As a further example of a structural feature, a region of the circumference of the wheel attachment may have a zig-zag conformation to allow a concertina-like stretching and contraction to provide a lengthening and shortening function.

This method of rolling the wheel onto the attachment is particularly advantageous for wheelchair users because it can be executed while the user remains in the chair, and also generally without the need for assistance. Once all of the attachment 10 has been applied to the wheel, the user rolls the wheel forward or back until the ends are close to his/her hands, a which type a joining means of some type (such as a clip) may be applied so as to retain the attachment securely on the wheel as will be described more fully infra. Removal of the attachment 10 is the reverse of the method just described.

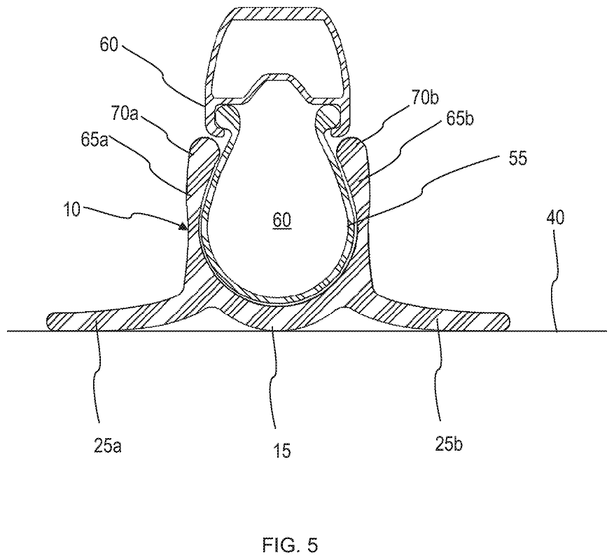

The attachment 10 as applied to a pneumatic tyre, and in the splayed configuration is shown in FIG. 5. As will be noted, the attachment 10 conforms closely to the outer surface of the tyre wall 55. Such close conformity is preferred such that the tyre 55 does not slip within the attachment 10 when the tyre 55 is rotated, and furthermore prevents the attachment 10 from rolling off or pulling off in the course of a sharp turn. The face 35 and/or the internally facing surfaces of the lateral regions 65a, 65b of the wheel attachment 10 may be configured by way of structure or fabrication material so as to frictionally engage with the outer surface of the tyre 55.

When the wheel is under load (for example, when a user is sitting in a wheelchair), as shown in FIG. 5 the extensions 25 and 25b are splayed and in that position act to urge the lateral portions 65a and 65b of the attachment 10 against the side walls of the tyre 55.

It will be further noted that the termini 70a and 70b of the lateral portions 55a and 55b respectively are formed so as to occupy the space adjacent the wheel rim 60. As will be appreciated, when pushing the attachment 10 onto the tyre 55, the lateral portions 65a and 65b are firstly deflected outwardly by the bulbous lower portion of the tyre. As the attachment is continued to be pushed onto the tyre, the lateral portions 65a and 65b return to their non-deflected state as the termini 70a and 70b are allowed to set into the more narrow region of the tyre 55 adjacent the rim 60.

The air pressure within the tyre cavity 60 also acts to exert and outward force to bear the tyre wall against the inner contour surface 35 of the attachment 10. As for the features described above, this acts to more securely retain the attachment 10 on the tyre 55.

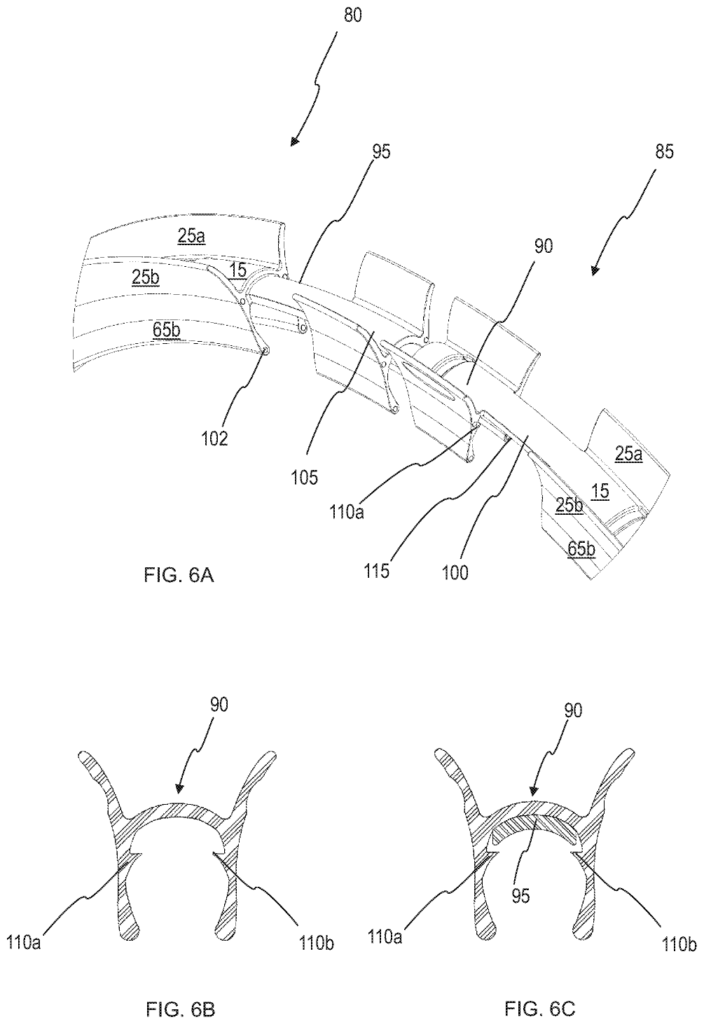

A preferred joining means of the attachment is shown at FIG. 6A, which shows the ends of the attachment 10 juxtaposed as would be the case where it has been applied to circumference of a wheel. The first end region 80 is applied to the wheel (not drawn) and the second end region 85 is left free. The second end region 85 is brought over the first end region 80 such that the engagement portion 90 overlies the cut-out portion 95, and the cut-out portion 100 overlies engagement portion 105. The engagement portion 90 is pushed down onto its respective underlying cut-out portion 95 such that the downwardly facing contoured surface 35 seats onto and conforms about the upwardly facing surface thereof in a push-lock manner. Paired locking members 110 insert under the cut-out portion 95 for greater security. Reference is made to FIG. 6B showing the cross-section of the relevant area to demonstrate more clearly the paired locking members 110a and 110b. FIG. 6C shows the paired locking members 110a and 110b as inserted under the cut-out portion 95 as occurs when the two end regions 80, 85 of the attachment 10 are secured together.

Concomitant with the step above, the downwardly facing surface 115 of the cut-out portion 100 is brought to lie on its respective underlying engagement portion 105 such that the downwardly facing surface 115 rests on the upwardly facing surface of the engagement portion 105.

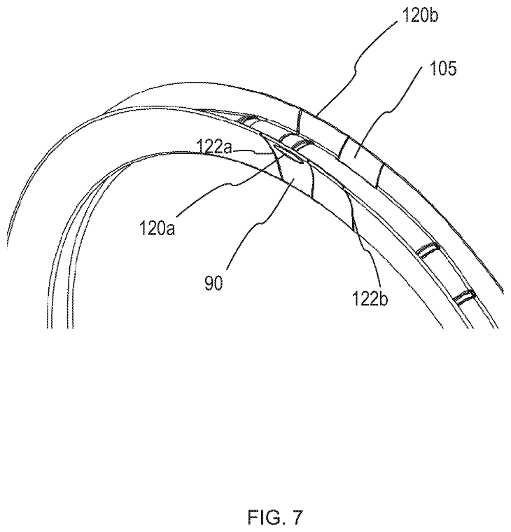

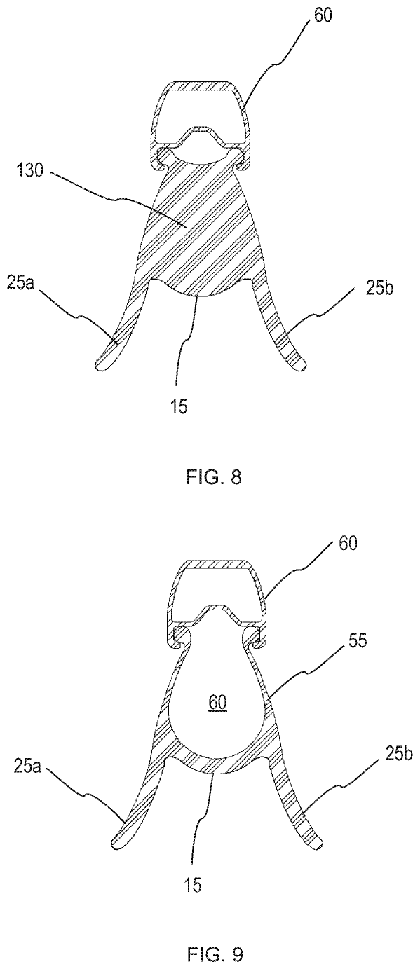

The joining means may be configured so as to prevent the user from incorrectly overlaying the end portion 80 over the end portion 85. For example, the junctions 122a and 122b of the preferred joining means shown in FIG. 7 are angled (by virtue of the adjoining portions being complementarily wedge-shaped) thereby preventing incorrect assembly.

Upon joining, each of the extensions 25a and 25b at each of the ends of the attachment 10 abut, and the support surfaces 15 at each end of the attachment 10 also abut so as to form a substantially continuous structure, as shown in FIG. 7. In this way, as the wheel with attachment 10 turns, an increased surface area is always presented to the underlying substrate so as to inhibit sinking into the substrate. To assist in maintaining the continuity of surfaces about the joining region, as shown in FIG. 6A there are provided a series of projections (one of which is marked 102) extending from end faces as shown, each of the projections inserting snugly into a depression (not shown) on an abutting end face so as to stabilise the join.

To release the attachment 10, the user locates the fingers and thumb in the recesses 120a and 120b respectively and squeezes together the upper portions of the extensions. This acts to move the locking members 110a and 110b (as shown in FIG. 6B) laterally so that the engagement portion 90 can be lifted upwardly. The recesses 120a and 120b are of course not essential and merely assist a user in releasing the attachment 10.

An advantage of certain embodiments of the present invention is that the body and clothing of a wheelchair user is not negatively affected by the wheel or wheel attachment. Further advantage is provided where the outwardly facing surfaces of the extensions 25a and 25b, and/or the lateral portions 110a and 110b present a smooth surface so as to not catch on any part of the user's body or the user's clothing as the wheelchair wheels rotate. Smooth surface in these regions may also inhibit the collection of mud or dirt.

The present invention may be embodied in another aspect in the form of a wheel per se, having a support surface in the usual manner but modified so as to comprise extensions which increase the surface area presented to a substrate when under load so as to prevent sinking of the wheel. An exemplary embodiment is shown in FIG. 8, where the solid tyre body 130 is mounted on a wheel rim 60. The extensions 25a and 25b are integrally formed with the body 130. This embodiments functions in the same manner as the attachment embodiment in so far as the extensions 25a and 25b splay outwardly under load such that the support surface 15 and extensions 25a and 25b present an increased surface area to an underlying substrate (not drawn).

An alternative to the embodiment of FIG. 8 is shown at FIG. 9 which details a pneumatic tyre 55 having integral extensions 25a and 25b.

The extensions of the present invention may be configured in any way such that when a load is applied to the wheel or the wheel attachment, the extensions deform in some manner so as to present an increased surface area to the underlying substrate. It is emphasised that extensions different to those shown in FIGS. 1 through 9 are included in the ambit of the present invention.

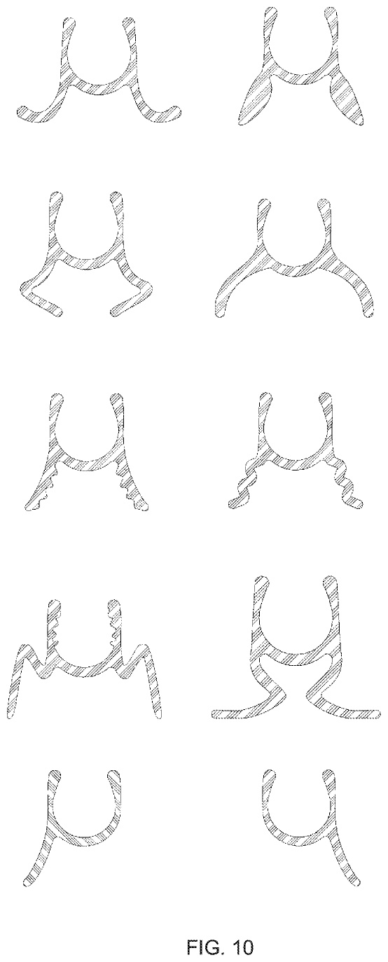

For example, the invention will be operable where the extensions do not splay or deflect in any way. An extension may be a deformable mass composed of a polymer which spreads laterally under load when pressed against an underlying substrate so as present an increased surface area to the substrate.

Where the extensions are finger-like projections as shown in FIGS. 1 through 9, many variations in shape and dimension will be operable. A series of alternative extensions are shown at FIG. 10. It will be noted that two of the variations have only a single extension. It is contemplated that some advantage may be gained where a single extension is used. For example, in a paired wheel application, the extensions may be provided only on the outer lateral side of each wheel. This arrangement will still provide resistance to sinking but may be more economical to manufacture.

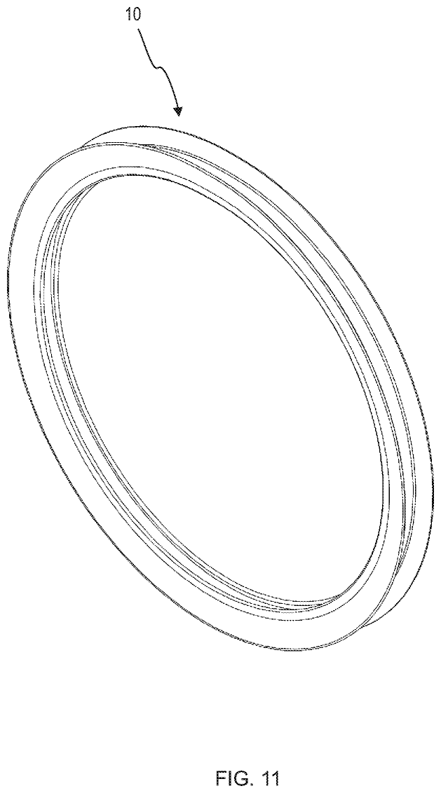

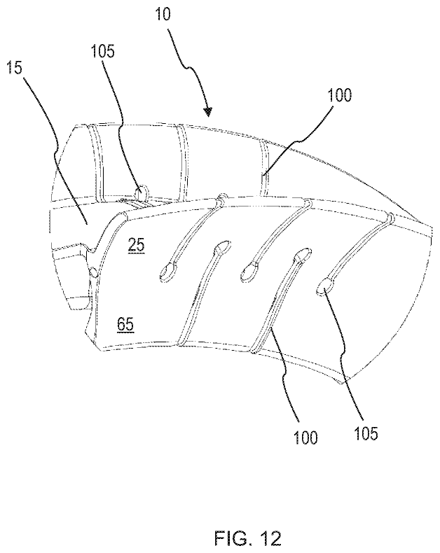

A further option is for the surfaces of the extensions which contact the underlying substrate (such as the surfaces marked 30a and 30b in FIG. 2B) to be configured to not provide not only resistance to sinking, but also traction. Thus, the contact surfaces of the extensions may comprise tread, projections, studs or similar means for increasing the frictional engagement with the substrate.

Where the invention is embodied in the form of an attachment, it is not necessary for it to require a joining means. Also operable will be embodiments where the attachment is in the form of a preformed loop which is intended to remain in looped conformation. In such embodiments, the attachment may have a level of elasticity to allow it to be stretched over a wheel. As will be understood, some rigidity is nevertheless required given the need for the extensions to act as a support against sinking, and a balance will be required with the elasticity required to allow for sufficient stretching. An exemplary embodiment in the form of a permanently closed stretchable loop is shown in FIG. 11.

A further advantage of some wheel attachments embodiments of the invention is the dramatic saving in weight provided. In the prior art, an entire replacement wheel set need be carried, the replacement wheels used to substitute the regular wheels when soft or uneven terrain is encountered. The present wheel attachments are light and can be easily folded and stored in a bag carried by the user.

As discussed elsewhere herein, the various aspects of the present invention may be fabricated from a polymeric material. The polymeric material may, on its own, provide acceptable performance for the intended function. However, in some embodiments a wire, a mesh or some other structure may be incorporated into the polymeric material or applied to the polymeric material so as to confer some desirable property such as durability or resilience. Composite materials such as a polymeric material with an additive or a filler material may also be useful to lower the cost of production or to provide improve ride quality, for example.

Those skilled in the art will appreciate that the invention described herein is susceptible to further variations and modifications other than those specifically described. It is understood that the invention comprises all such variations and modifications which fall within the spirit and scope of the present invention.

While the invention has been disclosed in connection with the preferred embodiments shown and described in detail, various modifications and improvements thereon will become readily apparent to those skilled in the art.

Accordingly, the spirit and scope of the present invention is not to be limited by the foregoing examples, but is to be understood in the broadest sense allowable by law.

1. A rolling element comprising:
a first support surface formed as a loop configured to roll on a substrate such that a region of the first support surface alternately contacts and separates from the substrate,
a first extension running about the loop and disposed about the first support surface, wherein where the rolling element is disposed on the substrate and a load is applied thereto:
in a first region of the loop where the first support surface is separate from the substrate the first extension extends beyond the first support surface, and
in a second region of the loop where the first support surface contacts the substrate the first extension is deformed so as to form a second support surface which contacts the substrate.

2. The rolling element of claim 1, comprising a second extension running about the loop, the second extension being disposed about the first support surface,
wherein where the rolling element is disposed on the substrate and a load is applied thereto:
in a first region of the loop where the first support surface is separate from the substrate the second extension extends beyond the first support surface, and
in a second region of the loop where the second support surface contacts the substrate the second extension is deformed so as to form a third support surface which contacts the substrate.

3. The rolling element of claim 2, wherein the deformation of the first extension and the second extension in the second region of the loop is a splaying of the first extension and the second extension.

4. The rolling element of claim 2, wherein the first support surface is disposed between the first and second extensions.

5. The rolling element of claim 1, wherein in the first region of the loop the second support surface face generally inwardly.

6. The rolling element of claim 1, wherein in the first region of the loop the first extension is splayed slightly outwardly, with the terminus of the extension remaining extended beyond the first support surface.

7. The rolling element of claim 1, wherein where the substrate is substantially horizontal, planar and solid; in the second region of the loop the second support surface is substantially horizontal.

8. The rolling element of claim 1, wherein the first support surface is the substrate-contacting surface of a wheel, or the substrate-contacting surface of a caterpillar track.

9. The rolling element of claim 2, wherein the first extension and the second extension are fabricated from a deformable and resilient material such that upon separation from the substrate the first extension and the second extension return to a default state whereby the first extension and the second extension extend beyond the first support surface.

10. The rolling element of claim 1, wherein the load is of a magnitude that is the same or similar to that expected for a predetermined application of the rolling element.

11. The rolling element of claim 1, wherein the load is applied to one or more points or regions of the rolling element that is the same or similar to that expected for a predetermined application of the rolling element.

12. The rolling element of claim 1, configured as a wheel or as a caterpillar track.

13. An attachment configured to be applied to and retained on a rolling element, the attachment comprising:
a first support surface formed as (i) a loop, or (ii) in linear form that is formable into a loop,
the first support surface configured to roll on a substrate such that a region of the first support surface alternately contacts and separates from the substrate,
a first extension running about or along the loop and disposed about the first support surface,
wherein where the attachment is applied to a rolling element, and the rolling element is disposed on the substrate and a load is applied thereto:
in a first region of the loop where the first support surface is separate from the substrate the first extension extends beyond the first support surface such that the first and second support surfaces are separate from the substrate, and
in a second region of the loop where the first support surface contacts the substrate the first extensions is deformed so as to form a second support surface which contacts the substrate.

14. The attachment of claim 13, comprising a second extension running about the loop or along the linear form, the second extension being disposed about the first support surface,
wherein where the attachment is applied to a rolling element and the rolling element is disposed on the substrate and a load is applied thereto:
in a first region of the loop where the first support surface is separate from the substrate the second extension extends beyond the first support surface, and
in a second region of the loop where the second support surface contacts the substrate the second extension is deformed so as to form a third support surface which contacts the substrate.

15. (canceled)

16. (canceled)

17. (canceled)

18. (canceled)

19. (canceled)

20. The attachment of claim 13, wherein the first support surface overlies the substrate-contacting surface of a wheel, or the substrate-contacting surface of a caterpillar track.

21. (canceled)

22. (canceled)

23. (canceled)

24. The attachment of claim 13, formed into a loop and configured so as to be stretched over the rolling element, and allowed to contract about the rolling element.

25. The attachment of claim 13, in the form of one or more lengths configured to allow attachment without stretching.

26. (canceled)

27. The attachment of claim 25, comprising joining means configured to allow joining two ends of the one or more lengths for the purpose of forming a loop.

28. The attachment of claim 13 having a cross sectional profile comprising opposing arms configured to (i) deform about a side wall of a rolling element during application, and (ii) resiliently grip onto the side wall when the attachment is fully seated onto the rolling element.

29. The attachment of claim 28, configured such that deformation of the extensions causes the arms to grip onto the rolling element.
